(19) United States
(12) Patent Application Publication
(10) Pub. No.: US 2004/0261194 A1
(43) Pub. Date: Dec. 30, 2004

(54) Fabric article treating system

(75) Inventors: Kenneth Nathan Price, Wyoming, OH (US); Shulin Larry Zhang, West Chester, OH (US); Marc Eric Gustwiller, Cincinnati, OH (US); Paul Amaat Raymond Gerard France, West Chester, OH (US); Michael Jason Ullom, Mason, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/876,860

(22) Filed: Jun. 25, 2004

Related U.S. Application Data
(60) Provisional application No. 60/483,153, filed on Jun. 27, 2003.
(60) Provisional application No. 60/483,155, filed on Jun. 27, 2003.

(51) Int. Cl. C11D 1/00

(52) U.S. Cl. 8/137

(57) ABSTRACT

A fabric article treating system, including the apparatus and the process, to provide improved fabric cleaning, fabric appearance and/or fabric care benefits. More particularly, the present system provides an effective delivery of detergent actives and rinse actives by depositing the actives directly upon a fabric article being treated. The detergent composition and fabric care composition suitable for use in such apparatus and process are also provided. The system is water-saving and energy efficient, compared to conventional immersive aqueous laundry system.

### CROSS REFERENCE TO RELATED APPLICATIONS

This application claims the benefit of U.S. Provisional Application Ser. No. 60/483,153, filed on Jun. 27, 2003; and U.S. Provisional Application Ser. No. 60/483,155, filed on Jun. 27, 2003.

### FIELD OF THE INVENTION

The present invention relates to a fabric article treating system, including the apparatus and the process, to provide improved fabric cleaning, fabric appearance and/or fabric care benefits. More particularly, the present invention relates to an effective and direct delivery system whereby detergent actives and rinse actives are directly deposited upon a fabric article being treated. The present invention also relates to novel detergent composition and fabric care composition for use in such apparatus and process. The system is water-saving and energy efficient, compared to conventional immersive aqueous laundry system, while providing enhanced fabric cleaning and fabric care.

### BACKGROUND OF THE INVENTION

Conventional aqueous-based laundering apparatuses and processes typically employ the immersive mode of laundering, that is, the amount of wash medium in the chamber is far above the absorptive capacity of the fabric load such that the fabric articles are bathed in “free” or excess wash medium. However, complete immersion may not be an effective or economical way to deliver detergent actives or rinse actives. When diluted in large quantity of aqueous wash medium, only a small percentage of the actives come into contact with the fabric articles while most of the actives are lost in the wash and rinse fluids. Moreover, certain actives have a higher affinity for water than the affinity for the fabric surface such that these actives fail to partition out of the aqueous wash medium and onto fabric surface effectively even when the actives happen to contact fabric surface.

There has been a long-felt yet unmet need in the fabric detergent art to be able to deliver highly water-soluble actives onto the fabric surface without significant waste of actives down the drain. Delivering certain actives that have high water solubility to the fabric surface places the laundry detergent formulator in the unfortunate position of having to work the paradigm of the required chemistry. On one hand, the high degree of polarity is what enables the actives to perform and deliver the desired benefits, such as cleaning or interacting with soils; on the other hand, these very same features prevent the actives from efficient partitioning out of solution, and most of the active “goes down the drain”. So far, there are few if any satisfactory ways to achieve this objective. For example, strategies to enhance the surface activity of the active usually attenuate the polar/hydrophilic properties that are desired for performance, and “delivery enhancement actives” (e.g. high molecular weight polymers) often result in less effective cleaning or are expensive.

In an alternative approach, the actives are delivered via a low volume of wash medium or delivered to the fabric surface directly. However, it remains a challenge to distribute the low volume of actives evenly or substantially evenly over the entire fabric surfaces in the fabric load in the chamber. For example, surfactants delivered only to certain areas and not to others would result in uneven cleaning, or even to unacceptable failure in cleaning performance. Another example is perfume: perfume is an expensive and very potent active; therefore, a small volume of perfume is typically used in a fabric article treating process and substantially even distribution is necessary. In other words, it is not desirable to deliver perfume in such a manner that one treated fabric article is drenched in perfume while another treated fabric article receives only a drop of perfume in one area.

Based on the foregoing, it is desirable to have a way of delivering these actives onto the fabric surface effectively and economically. This delivery method would make it feasible to treat fabric articles with currently available or novel actives having a low partition factor between the aqueous medium and the fabric surface. This delivery method would also make it feasible to treat fabric articles with expensive actives.

Based on the foregoing, it is further desirable to have a way of achieving even or substantially even distribution of the low volume of actives over the entire fabric surface such that the treated fabric articles do not exhibit blotchy or uneven benefits.

### SUMMARY OF THE INVENTION

In one aspect of the present invention, a fabric article treating process for effective cleaning fabric articles in a laundering apparatus is provided. The process comprises the steps of:

a. placing fabric articles comprising soils inside a treatment chamber of the laundering apparatus;

b. dispensing into the treatment chamber a wash liquor such that the fabric articles are substantially uniformly contacted by the wash liquor;

c. allowing the wash liquor to remain in contact with the fabric articles for a period of time while the fabric article is in motion, continuously or intermittently;

d. dispensing into the laundering apparatus a first rinse liquor comprising water such that the first rinse liquor directly or indirectly contacts the fabric articles, wherein quantity of the first rinse liquor is sufficient to produce enough free water to adequately suspend the detergent active and soils, and the first rinse liquor is thereby converted into a first rinse liquor mixture comprising water, detergent active and soils;

e. removing at least part of the first rinse liquor mixture from the treatment chamber; and

f. optionally, steps (d) and (e) are repeated such that one or more subsequent rinse liquors are applied to the fabric articles, converted to subsequent rinse liquor mixtures, which are at least partially removed from the treatment chamber;

g. optionally, dispensing into the treatment chamber a finishing liquor such that the fabric articles are substantially uniformly contacted by the finishing liquor;

wherein the wash liquor comprises water and a detergent active which has an in-wash fabric-water partition ratio of less than about 0.3, and quantity of the wash liquor is from about 25% to about 200% of dry weight of the fabric articles.

In another aspect of the present invention, the above fabric article treating process is capable of effectively delivering specific rinse actives and/or fabric care adjuncts to the fabric articles being treated. The process comprises the above steps (a)-(g), wherein the first rinse liquor of step (d) comprises a rinse adjunct and at least one of subsequent rinse liquors in step (f) or the finishing liquor in step (g) comprises a fabric care adjunct.

In yet another aspect of the present invention, a fabric article treating apparatus capable of performing the process of the present invention is provided.

### DETAILED DESCRIPTION OF THE INVENTION

All ratios are weight ratios unless specifically stated otherwise.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”

As used herein, “and/or” means subject X or subject Y or both.

As used herein, “fabric article” means any article, composed of fabrics and/or fibers, that is customarily cleaned in a conventional laundry process or in a dry cleaning process. As such the term encompasses articles of clothing, bed linens, bath linens, table linens, drapery, furniture covers, carpets, and clothing accessories. The term also encompasses other items made in whole or in part of fabric, such as tote bags, sleeping bags, tarpaulins, tents, and the like. As used herein, “non-immersive” means that essentially all of the wash fluid is in intimate contact with the fabric articles. There is at most minimal amounts of “free” wash fluid. It is unlike an “immersive” process where excess wash fluid forms a bath in which the fabric articles are submerged. A process is non-immersive if the fluid applied is less than about 100% of the dry weight of the fabric article; at this applied fluid level, the fluids are substantially absorbed by the fabric articles and there is minimal amount of free fluid. However, it should be noted that different fabric types and weaves can vary greatly in their degree of water absorptiveness, hence, some thin fabrics made from artificial fibers will only absorb substantially less than 100% of their dry weight before additional water becomes “free wash fluid”, whereas some thick cotton fabrics may absorb substantially more than 100% (e.g. sometimes more than 200%) of their dry weight before additional water becomes “free wash fluid”. Thus, in an average load of household laundry, a process is non-immersive if the fluid applied in the process is less than about 80% of the dry weight of the fabric article load. As used herein, “dry weight of a fabric article” means the weight of a fabric article that has no intentionally added fluid weight.

As used herein, “fabric article treating/treatment composition” or “treating liquor” means a composition that comprises one or more fabric treating actives, including detergent actives, rinse actives or combinations thereof, and optionally, a polar solvent. Thus, the fabric article treating composition may be a detergent composition, a rinse composition or a rinse liquor. Suitable forms of the treatment compositions include, but are not limited to, liquids, gels, pastes, particles or powders. The composition may be mixed with a polar solvent, such as water, to form the liquors used in various steps of the fabric article treating process.

As used herein, “detergent active” or “detergent adjunct” means a material or combination of materials that can deliver cleaning, soil/stain removal or soil/stain masking benefits to a fabric article.

As used herein, “rinse active” or “rinse adjunct” means a material or combination of materials that can deliver one or more of the following fabric care or fabric finishing benefits to a fabric article: softening, crispness, water and/or stain repellency, refreshing, antistatic, anti-shrinkage, anti-microbial, durable press, wrinkle resistance, odor resistance, abrasion resistance, anti-felting, anti-pilling, appearance enhancement, and mixtures thereof.

“Average molecular weight” as used herein means the weight-average molecular weight of a polymer, as determined by gel permeation chromatography.

As used herein, “fabric article treating apparatus” means any apparatus designed to treat fabric articles, such as an automatic washing machine, horizontal-axis or vertical-axis, preferably horizontal-axis. Further, the fabric article treating apparatus is preferably a polar solvent-based fabric article treating apparatus, wherein a polar solvent is the primary liquid for rinsing the fabric articles after the cleaning and/or care step has occurred.

The fabric article treating apparatus may comprise a source of the fabric article treatment composition comprising a reservoir for storing the fabric article treatment composition and an applicator for applying the fabric article treatment composition from the reservoir to the fabric article.

Further, the fabric article treating apparatus preferably comprises a nozzle, more preferably a plurality of nozzles, suitable for delivering a fabric article treatment composition.

Fabric Article Treating Apparatus

An apparatus of the present invention can be built or modified from a conventional aqueous based laundering machine such that the modified apparatus is capable of applying a very low volume of a treating liquor (e.g., a neat detergent composition or a neat rinse composition) into a fabric treating chamber and onto fabric articles in the treating chamber. Specifically, the apparatus of the present invention is designed to provide uniform or substantially uniform treatment of the fabric articles. In one embodiment, laundering apparatus that guarantee homogeneous coverage of the fabric articles with the neat composition by intermittent spin and spray, concurrently with or followed by random tumbling until all the wash medium has been sprayed. For example, modifications of conventional low water wash appliances to deliver low levels of a treating liquor should be considered; such conventional water wash appliances are described in U.S. Pat. Nos. 4,489,574; 4,489,455; 5,191,669; 5,191,668; 5,233,718; and 5,671,494. Another example of automatic washing machine useful for such low volume treating process is described in detail in U.S. Pat. No. 6,691,536.

FIG. 1 is a schematic illustration of an embodiment of apparatus for carrying out the fabric article treating process in accordance with the present invention.

The apparatus 70 comprises a fabric article treating chamber 1 capable of receiving a fabric article to be treated directly with a detergent composition, or with a wash or rinse liquor comprising water. When a fabric article to be treated is present in the chamber and a wash liquor is introduced into the fabric treating chamber 1, the treating chamber 1 retains an amount of the wash liquor up to the non-immersive level of the fabric articles contained therein. Additionally, the treating chamber 1 can be a fluid pervious (e.g., via perforations in the side wall) chamber.

The apparatus 70 may optionally comprises an outer chamber 2 capable of receiving the wash or rinse liquor from the fabric article treating chamber 1 that is not retained in said fabric-treating chamber. The outer chamber 2 is configured to house the chamber 1. The outer chamber 2 typically comprises an exit port or drain 7 through which the fluid received by the outer chamber 2 exits the outer chamber 2. It is desirable that the exit of the fluid from the outer chamber 2 is at a rate such that the amount of wash liquor in the fabric treating chamber 1 does not exceed the non-immersive level of the fabrics contained within the fabric article treating chamber 1.

In some embodiments, treating chamber 1 and outer chamber 2 are of cylindrical construction and have a horizontal access opening 58, as shown in FIG. 2. The horizontal center line of the outer chamber, which is typically stationary with respect to the chamber 1 coincides with the axis of rotation 100 of chamber 1 movably mounted within the outer chamber 2. The chamber 1 can in general have any suitable pattern of perforations or openings and is designed consistently with design principles for maximizing fluid flow through its perforated surface without weakening it to an unacceptable extent. The chamber 1 is designed to remain fully rigid when rotated at a high speed in the presence of a load of fluid-containing fabric articles. Chamber 1 may contain strengthening elements, such as struts, not shown, and has a back face not visible in FIG. 1, which is typically flat, and may be perforated or non-perforated. The appliance is configured to preferentially direct at least the wash liquor toward the fluid-pervious surfaces of chamber 1, rather than toward the back face of the chamber 1.

In another embodiment, the rinse liquor contacts the fabric articles being treated by an indirect method, wherein the rinse liquor is first introduced into chamber 2, which is located outside the fabric article treating chamber 1, then the chambers are rotated such that the rinse liquor passes through the perforations and contacts the fabric articles inside the treating chamber 1.

As is more clearly illustrated in the cross-sectional views of FIG. 2, outer chamber 2 comprises a peripheral wall 62, a back wall 63 secured to one edge of the peripheral wall, a front wall 64 secured to the opposite edge of the peripheral wall; said front wall has a tubular-shaped extension 55 having an access opening 58 used to load and unload laundry from the apparatus 70. This flexible tubular-shaped extension 55 minimizes transmission of vibrations which occur during operation of the machine. Access opening 58, forms a gas seal with front door 59 which is secured about its outermost periphery to the front wall 56 of the washing machine cabinet. Front door 59 optionally includes additional means for assuring a good seal, such as rubber, synthetic rubber, or elastomeric sealing material formed into any suitable shape for assuring the seal. When the fabric treating apparatus 70 is in operation, the access door 59 is in the closed position shown in FIG. 2 and forms a “gas-tight” seal against the outermost portion of flexible tubular-shaped extension 55. The quality of the seal is sufficient to permit overpressures or reduced pressures in the appliance, but need not be of the quality required for extreme pressure, e.g., supercritical carbon dioxide operation. These latter elements are illustrated only in the cross-section of FIG. 2 to ensure maximum clarity in the remaining drawing figures.

As can be seen in FIG. 2, outer chamber 2 is supported by means of four suspension springs 47 (only two of which are shown) which are connected at one end to the uppermost portion of the outer chamber 2 and at their other end are secured to the fabric treating apparatus cabinet. The top spring 47a is connected to a load sensor 48 interfaced with controller. In variations of the appliance not shown, any desirable high-speed suspension, load balancing or stabilizer system, for example of types known or disclosed for modern European front-loader washing machines, can be adapted for use in the present apparatus.

In one embodiment, chamber 1 comprises a fluid-pervious (e.g., perforated) peripheral wall 65, a substantially imperforate back wall 66 secured to said peripheral wall and a substantially imperforate front wall 67, secured to the opposite edge of said peripheral wall.

Chamber 1 is rotatably secured to outer chamber 2 by means of drive shaft 49. Power to rotate chamber 1 is transmitted by means of a concentrically mounted drive pulley 50. The drive system comprises a variable speed drive motor 54 secured to peripheral wall 62 of outer chamber 2. Any movement of outer chamber 2 does not affect the speed of rotation of chamber 1. The output shaft 53 of drive motor 54 has a secured drive pulley 52. Pulley 52 is connected to pulley 50 by means of conventional drive belt 51. A possible alternative drive system, not shown in the figures, has instead of a single drive pulley 52, two drive pulleys, one eccentrically mounted and one concentrically mounted. In this alternative drive system power to rotate chamber 1 is transmitted to the external portion of drive shaft 49 either by means of an eccentrically mounted driven pulley or by means of a concentrically mounted driven pulley which are both secured in fixed relation to drive shaft. The eccentrically mounted driven pulley would be used to vary the speed of rotation of the chamber 1 throughout each revolution of the chamber, while the concentrically mounted driven pulley would be used to drive the chamber 1 at a constant speed of rotation throughout each revolution.

In one embodiment of the present invention, drive motor 54 is not only variable speed, but is also reversible so that chamber 1 may be rotated first in one direction and then in the opposite direction during specific portions of the laundering cycle. Reversing the direction of chamber rotation several times during stages of fluid application/removal provide more uniform agitation to the fabric articles being treated, hence more uniform application of the wash or rinse liquor, thereby providing more effective removal of soil and/or more uniform fabric care benefits. Conversions between rotation speed and G-force of any particular chamber can be calculated using the following formula

$$v = \frac{2 π r}{t}$$

$${a}_{c} = {v}^{2} / r$$

$${F}_{g} = {a}_{c} / g$$

Where

r is the radius of the drum;

t is the time in minutes of one revolution;

v is the velocity of rotation;

a_{c} is the centripetal acceleration;

g is 9.8 m/s⁻² (acceleration of earth's gravity); and

F_{g} is the G force.

For example a drum with a radius of 10.5″ would need to be rotated at 40 revolutions per minute (rpm) to generate a force of 0.5 G. Rotating the same drum at 55 rpm would generate a force of 0.9 G. These illustrative examples have no particular significance other than to illustrate the calculation, do not relate to any critical ranges of operation (these are given elsewhere herein) and cannot be construed as limiting of the scope of the present invention.

The apparatus of the present invention is configured to provide chamber 1 with more than one rotation speed with respect to the outer chamber 2. The variable rotation speed of treatment chamber 1 can be selected to achieve specific benefits during different stages of the wash/rinse cycle. In one embodiment, the treating chamber 1 is rotated at a speed of to generate a force of up to about 1 G, or from about 0.7 G to about 1 G, or from about 0.5 G to about 3 G, to tumble the fabric articles while the treating liquor is being applied such that more uniform deposition of the treating liquor on the fabric surface is achieved. Low speed rotation also causes agitation of the fabric articles inside the chamber 1. The chamber 1 can be rotated to generate a centrifugal force of from about 50 G to about 450 G, or from about 150 G to about 400 G, such that the fabric articles are “spun” or pressed against the walls to effectively remove treating liquors from the fabric articles and/or the chamber.

In another embodiment, the front wall 67 has a tubular-shaped extension 55 with an access opening 58, which is used to load and unload laundry from the fabric treating apparatus 70, and is concentrically aligned with the access opening 58 in outer chamber 2. Equally spaced on the inner circumference of peripheral wall 65 are three lifting vanes 60, having cross-section that are substantially triangular or other shapes. In a specific embodiment, each of the vanes is symmetrically-shaped about a radially extending line originating at the axis of rotation 100 of chamber 1 and passing through its altitude. This permits rotation of chamber 1 in opposite directions with equal lifting effect on the articles being laundered. It should be understood and appreciated that most conventional laundering machines do not have lifting vanes, while tumble-dryers have lifting vanes designed for low-speed and/or unidirectional “tumbling” operation. Further, the chamber 1 may comprise baffles or other structures a long its interior surface to aid in repositioning the fabrics contained therein.

In still another embodiment of the present invention, the treating chamber 1 comprises at least two rotatable portions (not shown) and the drive system is capable of rotating the treating chamber 1 in such a manner that relative rotation is produces between adjacent rotatable portions. This allows the fabric articles inside chamber 1 to be agitated at a higher rate than in a single portion, unitary chamber typically found in a conventional laundering machine. An example of such contra-rotation treating chamber is described in PCT publication WO 99/58753.

Pump 24 is connected to applicator 26 via conduit 25 in order to introduce fluids into interior of chamber 1. The applicator 26 may be a spray nozzle, an atomizer, a nebulizer or like device, of any suitable configuration.

Spray technology including spray qualities and nozzle types is well described in the reference Atomization and Sprays, by A. H. Lefebvre, Hemisphere Publishing Company, USA, 1989. There are many ways to apply the treatment fluids via spray applicators in accordance with the present invention.

Sprays vary in pattern, penetration length, shape, and droplet size among others. In one embodiment, applicator 26 is configured to deliver a flat fan spray and/or a cone spray. A solid cone spray is one wherein the droplets are fairly uniformly distributed throughout a solid conical spray volume. A hollow cone spray is one wherein the droplets are concentrated at the outer edge of a conical spray pattern. A fan spray or flat spray or flat fan spray produces a liquid sheet parallel to the major axis of the orifice, the spray pattern is in the shape of a sector of a circle of about a 75-degree angle and is elliptical in cross section.

A spray nozzle typically provides an average droplet size that is less than about 1200 microns, typically from about 100 to about 1000 microns, or from about 120 to about 500 microns, or from about 150 to about 300 microns. This average droplet size is measured by either a Malvern particle analyzer or high speed photography. When a spray nozzle is covered with a fine grid or a membrane to produce a finer mist of droplets with an average particle size of less than 100 microns, the spray pattern is typically disturbed by air movement in chamber 1. Higher rotation speed of the chamber 1, typically above 735 m/s², requires larger droplets in spray pattern.

The pressure in the delivery conduit 25 may be adjusted and optionally, be accompanied with a heater for adjusting the temperature, the present apparatus is capable of applying all types of fluids, gels, pastes and other materials, including Newtonian and non-Newtonian fluids, shear-thinning and non-shear thinning fluids, multiphase mixtures, emulsions, microemulsions, and dynamically changing emulsion systems.

In one embodiment of the present invention, a suitable spray nozzle is rated to deliver 0.5 gallons per minute (about 1.87 liters per minute) at 40 psi (about 275 kPa) fluid pressure, maximum pressure 100 psi (about 690 kPa), and forms a spray angle of 800.

In another embodiment, the treating liquor is delivered via multiple spray nozzles; each spray nozzle is positioned such that the liquor is sprayed from the multiple spray nozzles in a fashion to evenly distribute the fluid on the fabric articles being treated. In another embodiment, the apparatus has one nozzle for delivering the wash liquor and other nozzles for delivering the rinse liquor. Such other spray nozzles can operate at any suitable cycle (such as washing, rinsing, or extracting) in a fabric treating process and can be sequential with or concurrent with application and/or removal or the treating liquors.

In another embodiment, other applicators or dispensing devices, for example, atomizers, nebulizers, and like devices, are used. Nebulizers, atomizers or like devices are well known to those skilled in the art. These devices are capable of disintegrating a quantity of fluid into fine droplets. A typical applicator of this type is capable of providing droplets having average particle size less than about 100 microns, typically from about 0.1 to about 60 microns, or from about 0.5 to about 40 microns, or from about 1 to about 20 microns. Due to the small particle size, the droplets are more susceptible to air movement in the chamber 1. An air circulation device, such as a fan, may be used to direct the droplets towards the walls 65, 66, 67.

Some well known atomizers include orifice atomizers which employ high speed ejection to produce droplets, pressure atomizers which convert pressure into kinetic energy to produce droplets, and ultrasonic atomizers which employ high frequency vibration to release fine droplets from the fluid surface. A suitable ultrasonic atomizer is commercially available under the tradename Acu Mist® from Sono Tek Corporation, Milton, N.Y. Still other examples of such devices are available from Omron Health Care, GmbH, Germany; and from Flaem Nuove, S.P.A, Italy. Likewise, aerosol delivery systems, which are well known to the art, can be used to deliver the detergent and/or finishing compositions. Electrostatic dispensing devices can also be used to dispense the compositions to the chamber 1. Exemplary of such electrostatic dispensing devices are described in U.S. patent application Ser. No. 10/418,595 (P&G Case 8903) and PCT Publication WO 03/02291.

Other dispensing devices can be removably attached to the front door 59 are described in U.S. patent application Ser. Nos. 10/697,735; 10/697,685; and 10/697,736 (P&G Cases 9397, 9398, and 9400); U.S. Patent Application No. 2003/0200674A1; PCT publications WO 03/087285 and WO 03/087461. It is understood that these dispensing devices can be used to deliver the detergent composition, the finishing composition, and even the liphophilic fluid.

FIG. 2 shows an example of the internal configuration of applicator 26, as a spray nozzle in the following embodiments. The applicator 26 is shown in FIG. 2 as parallel to the axis of rotation 100 of the chamber 1. In another embodiment the applicator 26 is located on the axis of rotation 100 of the chamber 1. The applicator 26 is supported by a spraying arm 57 secured to the front door 59. The fluids are delivered to the nozzle 26 via duct 61 connecting fluid delivery conduit 25 to the nozzle 26. Applicator 26 is located parallel to the axis of rotation 100, so that it directs a flat, fan-shaped spray to strike peripheral wall 65, front wall 67, and back wall 66 of the chamber 1. Spray arm 57 allows spraying onto the front wall of the chamber 1 without any of the garments in the discrete fabric articles been wrapped around the spray arm 57 during tumbling cycle and consequently inhibit or possibly even prevent efficient cleaning of the discrete fabric articles.

In an alternative embodiment, not illustrated in the FIG. 2, the applicator 26 can be directly secured to flexible tubular-shaped extension 55, eliminating the need for spray arm 57 and duct 61. Thus, applicator 26 can be directly linked to fluid delivery conduit 25. Applicator 26 can be located in a position on the flexible tubular-shaped extension 55 which can allow it to direct a flat, fan-shaped spray to strike peripheral wall 65, front wall 67, and back wall 66 of the chamber 1. Different location and/or configuration of the applicator 26 and/or the spray arm 57 are also suitable so long as the applicator nozzle or plurality of nozzles is not located where the fabric articles in the chamber can get tangled with or wrapped around the spray arm 57, applicator 26, or any other structure associated with the applicator 26, during an operating cycle (e.g., a tumbling cycle). In one embodiment of the invention, the location and/or configuration of the applicator 26 (in the form of a spray nozzle or a plurality of such nozzles) is selected such that the applicator 26 directs a flat, fan-shaped spray to strike preferentially at the fluid-pervious peripheral wall 65, and optionally, to the front wall 67 and/or the back wall 66 as well.

In another embodiment of the present invention, the treating composition is delivered to the outer chamber 2 such that the fluid level in the outer chamber 2 is below the bottom of the fabric article inside treating chamber 1. During the treating process, the treating chamber 1 can rotate such that centrifugal forces and/or gravity pulls the treating composition through the perforations 46 of chamber 1 to come into contact with fabric articles inside chamber 1. Similarly, in an extracting or removing fluids step, the treating composition from chamber 1 can pass through the perforations 46 of chamber 1, and down the outer surface of the chamber 1 until they reach the bottom (i.e., the lowest point) of the outer surface of the chamber 1, pass through the perforations in chamber walls, then to the bottom of the inner surface of the outer chamber 2. Conduit 7 is located at this bottom (i.e., lowest point). The inner surface of the outer chamber is designed to direct all fluids/droplets into conduit 7. Fluids in conduit 7, as well as those from conduit 37, described in more detail hereinafter, are then fed into the filter 6 and tank 8 by means of a pump 3 having a maximum rated capacity of 3 gallons per minute and maximum pressure 50 psi (345 kPa). The delivery conduit 7 typically has a diameter of ½″ (127 mm).

Fabric Article Treating Process

Another aspect of the present invention provides a fabric article treating process. The process comprises the step of applying a low volume of detergent composition to the fabric articles such that the composition is substantially evenly distributed onto all portions of the fabric articles being treated and the subsequent steps of applying and extracting one or more rinse liquors sufficient to remove the detergent composition and/or soils, and to substantially evenly distribute rinse actives to all portions of the fabric articles being treated. Optionally, a finishing liquor comprising fabric care actives is applied to the fabric articles.

It is desirable that the fabric article is uniformly or substantially uniformly treated with the fabric article treatment composition such that the desired benefit is recognizable by a consumer. The extent of uniformity can vary depending upon the fabric article actives present in the fabric article treatment composition. For example, a perfume may not need to be entirely uniformly applied if its benefit is recognizable by a consumer without being entirely uniformly applied. Other the other hand, an anti-wrinkle agent may need to be applied uniformly in order for its benefit to be recognized by a consumer.

(A) Wash Liquor Application Step

The wash liquor for the present process can be a concentrated detergent composition applied to the fabric article “as is” or in its “neat form”. In this aspect of the present invention, the detergent composition is not diluted by any additional diluent, such as a polar solvent, prior to contacting the fabric article. In other words, the fabric article treatment composition, in neat form, contacts the fabric article prior to contacting any discrete diluent or other solution. This is unlike conventional washing systems where the fabric article treatment composition, such as a detergent, is added to an excessive amount of a diluent and/or other solution, such as water, to form a mixture which then contacts, or more typically bathes, the fabric article. “Neat form” refers to the detergent composition that a user obtained from a vendor of the composition, thus, the neat form can include water, in combination with fabric article actives. Water is typically present in liquid or paste detergent compositions in their neat forms.

In another aspect of the present invention, the wash liquor can also be prepared by mixing the paste or liquid concentrate detergent composition with water or dissolving/suspending the granular detergent composition in water to form a wash liquor, which is applied to the fabric article. The mixing or dissolving can be done outside of the apparatus, or can be done by placing the detergent composition in a wash liquor reservoir and fill it from a water supply line or in the case of a liquid concentrate, a flow through cell can be used to mix and prepare the wash liquor. As used herein, the term “wash liquor” is meant to encompass both the embodiment wherein the detergent composition is applied to the fabric article in its neat form, and the embodiment that a pre-dilute or pre-dissolved a detergent composition (e.g., liquid concentrate, paste, granules) is applied to the fabric article.

The wash liquor is applied to the fabric article being treated to achieve substantially uniform distribution over all portions of the fabric article. Non-uniform distribution of the wash liquor tends to create clean spots where disproportionate amount of the wash liquor contacts the fabric article and leaves the non-contacted portions or the less saturated portions of the fabric articles untreated or not as well cleaned. This is especially true where the amount of the wash liquor is about or below non-immersive level.

A combination of factors are employed in the system of the present invention to better achieve the substantially uniform distribution of the wash liquor to the fabric article, including, but not limited to, applying the wash liquor in fine droplets forms in a continuous manner or an intermittent/pulsed manner; moving or tumbling the fabric articles while the wash liquor is being applied such that all portion of the fabric article is exposed, wherein the moving or tumbling mode can be continuous or intermittent, forward or reverse, uni-, bi- or multi-directional; incorporating and/or using additional structural elements, such as lifting vanes, spray arms, contrarotating chamber sections, such that bundling of fabric articles during treatment is prevented or minimized.

The uniformity of the applied wash liquor, expressed as a Spray Uniformity Index, can be determined by the following method. A representative load of fabric articles (such as the mixed fabric load described in ASTM test D2960-98) is placed into the apparatus. Also included in the load are eight tracers comprising 25 cm×25 cm squares of white cotton fabric; each tracer is then marked with a wash-safe marker to subdivide the tracer into a grid of twenty-five 5 cm×5 cm squares. A wash liquor which has been spiked with 1% of a standard red dye solution is applied via the applicator to the amount of about 50% of the dry weight of the load. The swatches are then removed, air-dried, and the color intensities of the tracers' 5 cm×5 cm square regions are each graded visually on a scale of 0-10 where a grade of 0 corresponds to a reference cotton swatch, and a grade of 10 corresponds to a white cotton reference swatch totally submerged in the dye-spiked wash liquor solution for 10 seconds and then dried. From the 200 grades obtained from the tracers, an average grade and standard deviation are calculated. The Spray Uniformity Index is the percentage of swatches whose grades fall within 0.5 standard deviation of the average grade. The process of the present invention is capable of delivering a Spray Uniformity Index of greater than about 90.

Thus, the process is extremely efficient because the quantity of wash liquor used can be as low as about 0.25 times of the dry weight of the fabric articles. The process also permits very effective detergent/soil interactions because no excess water is present to dilute the interactions. Furthermore, the process permits the use of certain hydrophilic detergent actives that are not effective in conventional immersive aqueous wash system because such detergent actives have relatively poor fabric affinity and would prefer to remain in the aqueous bath rather than being deposited onto the fabric surface and interacting with the fabric/soil. Specifically, the present process can employ actives having an in-wash fabric-water partition ratio (Qᵢ) of less than about 0.3 as described below.

In the process of the present invention, the amount of wash liquor used in the wash step is extremely low. By application of a low volume of the wash liquor directly onto the fabric articles in a substantially uniform manner, the resulting fabric articles are coated with a thin film of the wash liquor. Within such a thin film, the detergent actives are in intimate contact with the fabric surface and are able to suspend and/or remove soils from fabric surface. Moreover, errand dye molecules are confined by the thin film and is less prone to transfer to another fabric surface.

In one embodiment, the volume of the wash liquor applied during of the thin film wash step is less than about 75%, or less than about 50%, or less than about 25%, of the dry weight of the fabrics being treated. In another embodiment, the volume of the wash liquor applied is from about 50% to about 200%, or from about 75% to about 150%, of the dry weight of the fabrics being treated.

As the amount of wash liquor applied is reduced, it becomes more important to distribute the wash liquor uniformly over the fabric article surface so as to minimize spotty results from the low volume, thin film fabric treating process. To achieve uniform distribution, suitable applicator must be capable of producing an acceptable spray pattern that results in a uniform spray coverage, for example, having a Spray Uniformity Index of greater than 90, as described above.

The wash liquor may be applied in the form of a fog or a mist comprising droplets of the wash liquor, wherein at least 80% (D₈₀), or at least 90% (D₉₀) of the droplets have a droplet diameter of less than about 500 microns or less than 350 microns, or less than 200 microns.

In one embodiment of the present invention, a spray nozzle is employed, which is capable of delivering a flat fan spray in a solid cone spray volume wherein the droplet size falls within the ranges described above. Alternatively, an atomizer is employed, which is capable of producing a fine mist or fog comprising fine droplets with droplet size falling well within the ranges described above. Suitable applicators are described herein above in the Apparatus Section.

The wash liquor application process employs an amount of wash liquor to achieve an optimal wash liquor to fabric ratio, which is described below. Without being bound by theory, it is believed that the optimal wash liquor to fabric ratio is useful in achieving the following: (1) to ensure most of detergent is in intimate contact with the fabric, (2) to reduce dye transfer, soil redeposition, and suds, and (3) to preserve the inherent efficiency of the process. On one hand, if not enough fluid is added, the garments are not completely contacted with wash liquor; on the other hand, too much fluid is added, free (mobile) wash liquor is present, the concentrated wash liquor can migrate from one garment to another and cause problems such as dye crocking. It is previously believed that the optimal wash liquor to fabric dry weight ratio is between ¾:1 and 1 1/2:1. It has now been found that a thin film wash process can be improved or refined by taking into account factors, such as the variety of fabric materials, their form of weave and thickness, their degree of soiling, and other unforeseen factors which are beyond control of the detergent formulator. This is so because different fabric types and weaves can vary greatly in their degree of water absorptivity. For example, certain thin fabrics made from synthetic fibers will only absorb substantially less than 100% of their dry weight before additional water becomes “free” wash fluid, whereas thick cotton fabrics may absorb substantially more than 100% (e.g. sometimes more than 200%) of their dry weight before additional water becomes “free” wash fluid. If the overall load is skewed toward one or the other of fabric types, the optimal amount of wash liquor could vary significantly from the amount determined simply from the dry weight of the fabrics.

It has now been found that an improved or refined wash liquor to fabric ratio, namely the “absorptive capacity-weighted wash liquor to fabric ratio,” can specific the amount of wash liquor that both enables the abovementioned thin film distribution while avoiding excess wash liquor. The “absorptive capacity-weighted wash liquor to fabric ratio” is defined as follows:

Z:Y

Y=the total mass of the dry fabric load in kg

Z=ΣA₁B₁+A₂B₂+A₃B₃+ . . . AₙBₙ

where 1,2,3, . . . n=the number of different types/weaves of fabrics; Bₙ is the mass in kilograms of that portion of the fabric load comprising a given fabric/weave type; Aₙ is the absorption coefficient for a given fabric/weave type, and is equal to [M/100] where M is the amount of water in g that are absorbed by a 100 g swatch of said given fabric weave/type after said fabric is immersed in water and then centrifuged in a perforated basket for 5 minutes at 400 rpm.

Thus, the process of the present invention employs an optimal amount of wash liquor to deliver an improved fabric cleaning benefit in the range from about 0.25 to about 2, or from about 0.5 to about 2, or from about 0.75 to about 1.5, based on the absorptive capacity-weighted wash liquor to fabric ratio.

(B) Optional Incubation step

After the application step, the optional incubation step allows the fabric articles and the wash liquor to remain in contact for a period of time sufficient to allow the detergent actives and water in the wash liquor to interact with soils, stains, fabric surfaces. The incubation period may last at least about 1 minute, or at least about 3 minutes, or at least about 5 minutes. On the other hand, in order to make this process time efficient, the incubation period may last less than about 30 minutes, or less than about 15 minutes, or less than about 10 minutes.

Optionally, the incubation period can involve the thermal or non-thermal (e.g. by means of non-heated air circulation and/or venting) evaporative removal of water to further concentrate the thin film of wash liquor.

Optionally, after the fabric articles are contacted by the wash liquor, energy (thermal and/or mechanical energy) is applied to the fabric articles in the treating chamber. Thermal energy may be applied as heated air, steams, microwaves and other radiation energies. Mechanical energy may be applied by rotaing, countrarotating, tumbling the treatment chamber 1, and enhanced by vanes 46, fins, or other structures protruding from the walls of the treatment chamber.

Not wishing to be bound by theory, it is believed that thermal energy may enhance the detergency of the wash liquor, in the following ways. Thermal energy may improve the kinetics of composition/fabric/soil interactions. Thermal energy may promote transitioning of the wash liquor into a “liquid crystalline phase”, which exhibits more effective detergency. As used herein, “liquid crystalline phase” or “middle phase” refers to any organized micelle structures, including but are not limited to rodlike, hexagonal, and lamellar arrangements. At an operating temperature ranging from about 10° C. to about 70° C., the liquid crystalline phase can be achieved at a surfactant concentration of about 10% or greater. Thermal energy may raise the temperature sufficiently to cause the wash liquor on the fabric surface to partially lose its water content such that the wash liquor becomes more concentrated to promote interactions at fabric surface, formation of middle phase, and ultimately, detergency. Thermal energy may activate the bleach, inorganic peroxide salt activators or peroxyacids; non-limiting examples of these heat activatable materials are disclosed in U.S. Pat. No. 4,248,928; U.S. Pat. No. 4,220,562 and U.S. Pat. No. 4,100,095. Thermal energy may also promote enzyme activity.

Mechanical energy may help distributing the wash liquor so that it is more evenly distributed onto the fabric articles. Mechanical energy may also minimize the time period that the same fabric article surfaces are in contact with one another, thus, minimizes dye transfer. Mechanical energy also contributes to improved cleaning efficiency, for example, by loosening the soils from the fabric surfaces.

(C) Rinse Liquor Application Step

The rinse liquor may comprise pure water and, optionally rinse actives. Since a low volume of wash liquor is applied to the fabric surface to perform the thin film wash step, the detergent actives, the soils, as well as errand dye materials are concentrated on the fabric surface. Thus, the goal of the rinse step is to remove the detergent actives, soils and dye materials thoroughly. Moreover, if the removal of detergent actives, soils and dyes is done efficiently in the early stage when these materials are concentrated, soil redeposition and dye transfer can be minimized. At the same time, the total amount of rinse water used in the rinse step need to be limited in order to reduce water consumption and to minimize water-induced shrinkage in the treated fabric article.

Based on the above, an effective rinse can be accomplished by flushing the system with a large quantity of a first rinse liquor to produce enough free water on the fabric surface to adequately suspend the detergent actives, soils and dyes so that these materials are substantially removed by the first rinse. Generally, more than one rinse liquors are needed to remove all of the detergent actives, soils and dyes. The subsequent rinses need not use as much water as the first rinse liquor. In a typical embodiment, the amount of the first rinse liquor is from about 5 to about 20 times the dry weight of the fabric articles, and the amount of the subsequent rinse liquor is from about 1 to about 10 times of the dry weight of the fabric articles, or about ⅕ to about ½ of the first rinse liquor; and the total amount of water used in the rinse step(s) is from about 5 to about 50 liters, or from about 5 to about 20 liters.

In one embodiment, the complete rinse step comprises two to five cycles, or frequently, two to three cycles. The first rinse liquor is typically of pure water and the last rinse liquor may comprise water and optionally, rinse actives. Each cycle lasts about 1 to about 15 minutes, or about 3 to about 10 minutes, and each cycle need not be of the same length of time. In between rinse cycles, the rinse liquor is removed. Removal or extraction of rinse liquor can be achieved by rotating or spinning the treating chamber 1 at high speed to produce a centrifugal force of from about 50 G to about 450 G, or from about 150 to about 400 G. Other ways to remove the rinse liquor include, but are not limited to, using an inflatable bladder to squeeze out the rinse liquor, contacting sponge-like material to suck out the rinse liquor, using a vacuum pump to suck out the rinse liquor.

The rinse liquor may be applied in the form of droplets by the same or similar applicators used to apply the wash liquor, combined with tumbling to distribute the rinse liquor evenly, to promote intimate contact between rinse liquor and fabric articles, or to reduce the contact time between fabric surfaces such that soil redeposition and/or dye transfer between fabric surfaces are minimized. In one embodiment, due to the quantity of the rinse liquors applied, especially the first rinse, instead of spraying or misting, the rinse liquor is pumped into the chamber 1 at a rate of from about 1 to about 20 liters/minute, or from about 1 to about 10 liters/minute, or about 2-5 liters/minute. In another embodiment, the first rinse liquor is pumped in and the last rinse liquor is sprayed or misted.

In one embodiment, the rinse liquor is applied to the fabric articles in the treating chamber indirectly. That is, the rinse liquor is delivered to the outer chamber 2 to a level just below the bottom of the treating chamber 1, and by rotating or tumbling the treating chamber 1, the rinse liquor passes through the perforations on the wall of the treating chamber 1 and contacts the fabric articles therein. The advantage of the indirect method is that the fabric articles are not bathed in the rinse liquor and are in constant motion, thus, soil redeposition and/or dye transfer are minimized.

Tumbling, rotating or other movements of the fabric articles during the rinse step promotes even distribution of the rinse liquors. However, such movements need not be at high speed (e.g., less than 1 G). This is so to minimize the potential of wrinkling and/or bundling of the fabric articles. Even the removal of rinse liquors between cycles need not be performed at very high speed such that the fabric articles are not pinned to the wall of the treating chamber.

(D) Optional Steps

Optionally, a finishing liquor, similar to the subsequent rinse liquor or having lower water content than the subsequent rinse liquor, can be applied to the fabric article in the same way as the rinse liquor application such that the fabric articles are substantially uniformly contacted by the finishing liquor. Preferably, the finishing liquor comprises a fabric care active that is meant to be left on the fabric article. Thus, partial removal of the finishing liquor is optional, and in some embodiments, application of the finishing liquor is followed immediately with the drying step.

Optionally, the drying step can be conducted in the same apparatus after the last rinse cycle. The dual mode apparatus (i.e., washer and dryer in one apparatus) are known in the art. This option provide the added advantage of enabling the consumer to perform the entire (dry to dry) laundering process in a single apparatus and in continuous fashion, thus, a potential time saver.

Fabric Article Treatment Composition

The compositions of the present invention comprise at least one fabric treating active. The fabric treating actives may include detergent adjuncts and/or rinse actives.

The composition may also comprises a polar solvent, including water.

The fabric article active may be any suitable fabric article adjunct for fabric cleaning, fabric finishing, or fabric care. Thus, the fabric article active may be detergent actives, rinse actives and mixtures thereof.

Nonlimiting examples of detergent actives for use in the wash step include surfactants, bleaching agents, enzymes, optional builders, and mixtures thereof.

Nonlimiting examples of finishing actives for use in the rinse step include softening agents, brighteners, perfumes, soil release agents, anti-wrinkle agents and mixtures thereof.

Polar Solvent

The polar solvents according to the present invention exhibit at least one of the following Hansen solubility parameters:

a fractional polar value (f_{P}) of greater than 0.02 and/or greater than 0.05; and/or

a fractional hydrogen bonding value (f_{H}) of greater than 0.10 and/or greater than 0.2.

Nonlimiting examples of polar solvents suitable for use in the fabric article treatment composition of the present invention include: water, alcohols, glycols, polyglycols, ethers, carbonates, dibasic esters, ketones, other oxygenated solvents, and mixutures thereof. Further examples of alcohols include: C₁-C₁₂₆ alcohols, such as propanol, ethanol, isopropyl alcohol, etc, benzyl alcohol, and diols such as 1,2-hexanediol. The Dowanol® series by Dow Chemical are examples of glycols and polyglycols useful in the present invention, such as Dowanol® TPM, TPnP, DPnB, DPnP, TPnB, PPh, DPM, DPMA, DB, and others. Further examples include propylene glycol, butylene glycol, polybutylene glycol and more hydrophobic glycols. Examples of carbonate solvents are ethylene, propylene and butylene carbonates such as those available under the Jeffsol® tradename. Polar solvents for the present invention can be further identified through their dispersive (δ_{D}), polar (δ_{P}) and hydrogen bonding (δ_{H}) Hansen solubility parameters. Preferred polar solvents or polar solvent mixtures have fractional polar (f_{P}) and fractional hydrogen bonding (f_{H}) values of f_{P}>0.02 and f_{H}>0.10, where f_{P}=δ_{P}/(δ_{D}+δ_{P}+δ_{H}) and f_{H}=δ_{H}/(δ_{D}+δ_{P}+δ_{H}), more preferably f_{P}>0.05 and f_{H}>0.20, and most preferably f_{P}>0.07 and f_{H}>0.30.

In one embodiment, the polar solvent is selected from the group consisting of: water, alcohols, glycols, polyglycols, ethers, carbonates, esters, ketones, other oxygenated solvents, amines, amides, ureas, alkanolamines, alkanolamides phosphate esters, alkyl nitrites and mixtures thereof.

In one embodiment, the polar solvent comprises from about 0% to about 50% and/or from about 0.01 to about 20% by weight of water.

Detergent Actives

The present fabric article treating system is unique in that it permits the use of certain detergent actives that are not effective in treating fabrics when used in the conventional aqueous bath treating system. These detergent actives have a relatively low affinity for fabric surface (i.e., low fabric-water partition ratio) such that these actives would prefer to remain in the aqueous bath rather than being deposited onto the fabric surface. Detergent actives suitable for use herein have low fabric-water partition ratios, specifically, low “intra-wash fabric-water partition ratios”. The “intra-wash fabric-water partition ratio” is applicable to those actives whose presence at the fabric surface are desirable during the washing stage and that may be later rinsed away (e.g. bleaches, chelators).

For purposes of the present invention, the term “intra-wash fabric-water partition ratio” is defined as {(X−Y)/X}, where X is the mass of the active (which can be present as a component of a full detergent composition) added to a conventional immersive North American or European washing machine operating at the recommended water level and setting and a typical mixed fabric load, and Y is the mass of said active remaining in the collected effluent wash solution after the fabrics have been agitated for 10 minutes followed by removal of the wash liquor by drainage and spinning. A “mixed fabric load” is of the type described in Test #D2960-98 of the American Society for Testing and Materials. A Kenmore 3.2 cu. Ft. super capacity 27 in. top load washer can be used, with the machine setting at “Heavy Duty” and the water fill to approximately 17 gallons. Alternatively, a Miele Novotronic W918 washer can be used, with the machine setting at normal cycle (i.e., the short button) and water fill to about 11 liters for the wash and about 37 liters for 4 rinses.

Detergent actives suitable for use herein have an intra-wash fabric-water partition ratio (Qᵢ) of less than about 0.3, or less than about 0.2.

The present process can also employ hydrophilic detergent actives having an HLB (hydrophilic-lipophilic balance) value of at least about 8, or at least about 9, or from about 8 to about 12.

In one embodiment, the composition comprises representative surfactants having a suitable Q value for use in the present invention; these include but are not limited to, short (i.e., non-fatty) chain surfactants such as C6-C10 alkyl or aryl sulfonates, C6-C10 alcohols and their sulfonates, ethoxysulfonates, ethoxycarboxylates, and ethoxylate or alkoxylate derivatives. Further, the detergent composition comprises from about 1% to about 30%, or from about 3% to about 20%, or from about 5% to about 15% by weight of the composition of the hydrophilic surfactant.

Some suitable detergent adjuncts include, but are not limited to, builders, surfactants, other than those described above with respect to the surfactant component, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, anti-abrasion agents, fabric-enhancement amines, dye-fixative agents, fabric-rejuvenating agents, fiber-water protection agents, crystal growth inhibitors, photobleaches, heavy metal ion sequestrants, anti-tarnishing agents, anti-microbial agents, anti-oxidants, anti-redeposition agents, polymer dispersants, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof.

Suitable odor control agents, which may optionally be used as finishing actives, include cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful in the compositions of the present invention comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume, and are described in patents and/or published patent applications to Procter and Gamble, Firmenich, Givaudan and others.

Bleaches, especially oxygen bleaches, are another type of detergent adjunct suitable for use in the compositions of the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP) or other imido- or amido-substituted bleach activators including the lactam types, or more generally any mixture of hydrophilic and/or hydrophobic bleach activators (especially acyl derivatives including those of the C₆-C₁₆ substituted oxybenzenesulfonates).

Also suitable are organic or inorganic peracids both including PAP and other than PAP. Suitable organic or inorganic peracids for use herein include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof.

One class of suitable organic peroxycarboxylic acids has the general formula:

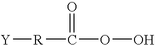

wherein R is an alkylene or substituted alkylene group containing from 1 to about 22 carbon atoms or a phenylene or substituted phenylene group, and Y is hydrogen, halogen, alkyl, aryl, —C(O)OH or —C(O)OOH.

Particularly preferred peracid compounds are those having the formula:

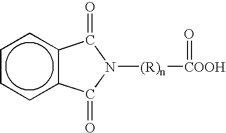

wherein R is C₁₋₄ alkyl and n is an integer of from 1 to 5. A particularly preferred peracid has the formula where R is CH₂ and n is 5 i.e., phthaloylamino peroxy caproic acid (PAP) as described in U.S. Pat. Nos. 5,487,818, 5,310,934, 5,246,620, 5,279,757 and 5,132,431. PAP is available from Ausimont SpA under the tradename Euroco.

Hydrogen peroxide is a highly useful bleaching agent.

Other detergent adjuncts suitable for use in the compositions of the present invention include, but are not limited to, builders including the insoluble types such as zeolites including zeolites A, P and the so-called maximum aluminum P as well as the soluble types such as the phosphates and polyphosphates, any of the hydrous, water-soluble or water-insoluble silicates, 2,2′-oxydisuccinates, tartrate succinates, glycolates, NTA and many other ethercarboxylates or citrates; chelants including EDTA, S,S′-EDDS, DTPA and phosphonates; water-soluble polymers, copolymers and terpolymers; soil release polymers; optical brighteners; processing aids; fillers; anti-redeposition agents; humectant; other perfumes or pro-perfumes; photobleaches; thickeners; simple salts; alkalis such as those based on sodium or potassium including the hydroxides, carbonates, bicarbonates and sulfates and the like; and combinations of one or more of these detergent adjuncts.

Another class of detergent adjuncts suitable for use herein are called “detergent-soil mixing promoting agents”. Without wishing to be bound by theory, it is believed that such agents assist the wash process in the following manner. Whereas shear mixing normally takes place in conventional aqueous washing processes, in the presence of a bath of free wash liquor, the extremely low wash liquor to fabric ratio in the thin film wash step of the present invention prevents a favorable degree of fluid shear at the fabric surface, resulting in a less than optimal degree of soil-detergent mixing. The “detergent soil mixing promoting agents” compensate for this deficiency by chemically promoting the mixture of soils with the aqueous detergent liquor within the thin film. Such agents include but are not limited to so-called “chelating surfactants” such as oleoyl sarcosinates; “solid-oil liquefying surfactants” such as lauryl amine oxide; hydrotropes such as sodium or calcium xylenesulfonate; and ‘short chain surfactants’ such as C6-C10 alcohols and their sulfate, ethoxysulfate, ethoxycarboxylate, and ethoxylate derivatives. In addition, another class of soil-detergent mixing promoting agent comprises lipases and esterases.

Another class of detergent adjuncts suitable for use herein are soil repleent agents, such as inorganic nanoparticles or polymers. Nonlimiting examples for nanoparticles include nanoparticles and/or functional colloidal particles selected from the group consisting of (a) inorganic metal oxides, natural clays, synthetic clays and mixtures thereof; (b) synthetic clays selected from the group consisting of kaolinite, montmorillinite/smectite, hectorite, synthetic fluorohectorite, illite, variants and isomorphous substitutions of the synthetic clay groups, and mixtures thereof; and (c) synthetic clays selected from the group consisting of layered hydrous silicate, layered hydrous aluminum silicate, fluorosilicate, mica-montmorillonite, hydrotalcite, lithium magnesium silicate, lithium magnesium fluorosilicate, and mixtures thereof. A suitable naoaparticle material is commercially available as LAPONITE® from Southern Clay Products, Inc, Austin, Tex. Nonlimiting examples of polymers suitable for use as the soil repellent agent include polyethylene glycols having a weight average molecular weight from about 1,000 to about 5,000,000 Daltons, polyacrylates having a weight average molecular weight from about 1,000 to about 5,000,000 Daltons, and carboxymethylcellulose having a weight average molecular weight from about 1,000 to about 5,000,000 Daltons.

In a typical embodiment, each detergent active comprises at least about 0.01%, or at least 0.1% or at least 1%, by weight of the detergent composition; and less than 99%, or less than 50% or less than 10%, by weight of the detergent composition.

Rinse Actives

Rinse actives suitable for use in the first rinse liquor include but are not limited to soil suspednig agents, hydrotropes, rinse activators, pH modifiers, and mixtures thereof.

Nonlimiting examples of soil suspending agents are selected from the group consisting of ethoxylated amines, zwitterionic polymers, polycarboxylates, polyalkyleneglycols, polyaminoacids, and combinations thereof.

One class of the the soil suspending agent is an ethoxylated amine selected from the group consisting of (a) a polyethyleneimine having an average molecular weight of about 189 to about 1800 daltons, each nitrogen in the backbone has a substituent (EO)ₓ wherein x is an integer from 7 to 30, and some or all of the terminal OH groups have been substituted with sulfate groups and/or some or all of the amine groups have been quaternized with methyl, ethyl, or benzyl groups; (b) a polyhexamethyleneimine having an average molecular weight of about 116 to about 550 daltons, each nitrogen in the backbone has a substituent (EO)ₓ wherein x is an integer from 7 to 30, and some or all of the terminal OH groups have been substituted with sulfate groups and/or some or all of the amine groups have been quaternized with methyl, ethyl, or benzyl groups; and (c) mixtures thereof.

Another class of the soil suspending agent is a polycarboxylate selected from the group consisting of water-soluble salts of polyacrylic acid, water soluble salts of poly(maleic acid)-co-poly(acrylic acid), carboxymethylcellulose, and mixtures thereof.

Nonlimiting examples of the hydrotrope is selected from the group consisting of metal salts of cumene sufonic acids, toluene sulfonic acid, or xylene sulfonic acid, and mixtures thereof.

Nonlimiting examples of rinse activator is selected from the group consisting of fatty mono- or oligo-amines, wherein one or more of the nitrogen in the backbone has backbone has a substituent (EO)ₓ wherein x is an integer from 7 to 30, and some or all of the terminal OH groups have been substituted with sulfate groups and/or some or all of the amine groups have been quaternized with methyl, ethyl, or benzyl groups; analogs of the ethoxylated fatty amines or quaternized fatty ethoxylated; and mixtures thereof.

Nonlimitng examples of dye transfer inhibition polymers are selected from the group consisting of polyvinylpyrrolidone, polyvinylpyridine-N-oxide, poly(vinylpyrrolidone)-co-poly(vinylimidazole), manganese phthalocyanine, peroxidases, and mixtures thereof.

PH modifiers include commonly known pH buffer materials.

Fabric Care Actives

Fabric care actives can be incorporated into the subsequent rinse liquor or the finishing liquor, the latter is intended to be left on the treated fabric articles, that is, the finishing step is not followed by subsequent rinse step.

Fabric care actives suitable for use herein have low fabric-water partition ratios, specifically, low “post-rinse fabric-water partition ratios”. The term “post-rinse fabric-water partition ratio” is defined as {(X−Z)/X}, where X is defined as above, and where Z is the mass of said active remaining in the collected combined effluent wash and rinse liquor(s) after the fabrics have been washed and rinsed on a “mixed fabric load” according to the machine setting and water level as described above. The “post-rinse fabric-water partition ratio” is applicable to those actives which are desired to remain on the fabric into the drying and/or wearing period (e.g. aesthetic benefit agents, soil repellent finishes, perfumes, etc.)

Fabric care actives suitable for use herein have a post-rinse fabric-water partition ratio (Q_{P}) of greater than about 0.2, or greater than about 0.3.

Suitable fabric care actives include, but are not limited to, anti-abrasion agents, fabric enhancement agents, crystal growth inhibitors, dye fixative agents, fabric softening agents, fabric rejuvenating agents, fiber/water protection agents, soil repellent agents, and mixtures thereof. Some of these fabric care actives are disclosed in details below.

Non-limiting examples of anti-abrasion agents are selected from the group consisting essentially of homo or copolymers containing any one or more of the following monomers: acrylamide, vinylamine, 3-trimethylammoniopropyl acrylate, N-alkylvinylpyridine, N-oxide-vinylpyridine, vinylalcohol, dialkyldiallylammonium chloride, N,N-dialkylamino alkylmethacrylate, N,N-dialkylamino alkylacrylate, N,N-dialkylamino alkylacrylamide, N,N-dialkylamino alkylmethacrylamide, and the quaternized derivatives thereof.

Non-limiting examples of dye fixative agents may be selected from the group consisting of the Sandofix™, Sandolec™, Lupasol-SK™, and Cartafix™ varieties; copolymers of epichlorohydrin and amines such as imidazole, dimethylaminopropylamine; polyvinylamine; water soluble salts of magnesium(II) and zinc(II), and aluminum (III); the hydrochloride, acetate, metosulphate and benzyl hydrochloride salts of diamine esters, the N-oxides of tertiary amines; derivatives of polymeric alkyldiamines, polyamine-cyanuric chloride condensates, and aminated glycerol dichlorohydrins.

Non-limiting examples of fabric enhancement agents are amines selected from the group consisting of triethanolamine; monoethanolamine; N,N′-bis(3-aminopropyl)-1,3-propylenediamine (TPTA), dipropylenetriamine (5-N′-methyl dipropylenetriamine), 1,4-piperazines, their N-alkylated and N-hydroxyalylated derivatives, and mixtures thereof. Preferred fabric rejuvenating agents are selected from the group consisting essentially of aminopropylated polydimethylsiloxane, aminopropyl-aminoethylated polydimethylsiloxane, aminosilicones, cationic aminosilicones, polydimethylsiloxanes; polydimethylsiloxanes or trisiloxanes with pendant polyethylene or polyethylene/polypropylene sidechains, alkylated or hydroxyalkylated celluloses

Non-limiting examples of crystal growth inhibitors may be selected from the group consisting of glycolic acid, phytic acid, polycarboxylic acids, polymers and co-polymers of carboxylic acids and polycarboxylic acids, ether hydroxypolycarboxylates, polyacrylate polymers, copolymers of maleic anhydride and the ethylene ether or vinyl methyl ethers of acrylic acid, citric acid and soluble salts thereof, 3,3-dicarboxy-4-oxa-1,6-hexanedioates, alkyl and alkenyl succinic acid and salts thereof, organo-diphosphonic acids or salts such as ethylene diphosphonic acid, alpha-hydroxy-2 phenyl ethyl diphosphonic acid, methylene diphosphonic acid, vinylidene-1,1-diphosphonic acid, 1,2-dihydroxyethane-1,1-diphosphonic acid, hydroxy-ethane 1,1 diphosphonic acid, the salts thereof, and mixtures thereof.

Non-limiting examples of fiber-water protecting agents may be selected from the group consisting of low molecular weight aliphatic or aromatic alcohols, low molecular weight alkylene glycols, low molecular weight alkylene glycol ethers, low molecular weight esters, or low molecular weight alkylene amines or alkanolamines. Herein, “low molecular weight” means the molecule's backbone length is less than 12 carbons, or is about C6-C10 in length.

Nonlimitng examples of fabric softening agents may be cationic dialkyl or sister quaternary ammonium salts.

In a typical embodiment, each rinse active comprises at least about 0.01%, or at least 0.05% or at least 0.1%, by weight of the detergent composition; and less than 99%, or less than 10% or less than 5%, by weight of the rinse active composition.

Nonlimiting Examples of the Thin Film Laundering Process

### Example 1

place a load of fabric articles (such as garments) into a horizontal axis automatic washing machine;

begin tumbling the fabric articles at a speed capable of generating a force of about 1 G;

spray/mist a wash liquor comprising 75 g of a detergent composition diluted in enough water such that the resulting liquor to fabric ratio is between 0.25:1 to 2:1 onto the tumbling clothes according to droplet size and other spray/mist requirements described above;

continue tumbling for a total tumbling time of about 15 minutes;

rapidly add (e.g., by pumping at a rate of 1.87 liters per minute) fresh water to the tumbling load such that the resulting liquor to fabric ratio is about 15:1;

high-speed spin to remove all excess liquor;

resume tumbling and spray/mist a finishing composition comprising 50 g of finishing actives diluted in enough water such that the resulting liquor to fabric ratio is between about 2:1 to 5:1 onto the tumbling clothes according to the spray/mist requirements of the invention;

high-speed spin (e.g., at a rate of at least about 450 rpm) to remove of at least all free liquor;

optionally, tumble drying in the same apparatus.

### Example 2

place a load of garments into the horizontal axis machine;

begin tumbling the fabric articles at a speed capable of generating a force of about 0.5 G to about 3 G;

add fresh water and spray/mist 75 g of detergent composition onto the tumbling clothes such that the resulting liquor to fabric ratio is about 7:1;

continue tumbling for a total tumbling time of 15 minutes while heat is applied to partially remove water from the applied liquor such that the remaining liquor to fabric ratio is about 0.75:1 or less;

rapidly add fresh water to the tumbling load such that the resulting liquor to fabric ratio is about 15:1;

high-speed spin to remove of at least all free liquor;

rapidly add fresh water to the tumbling load such that the resulting liquor to fabric ratio is about 7:1;

high-speed spin to remove of at least all free liquor;

resume tumbling and spray a rinse liquor comprising about 30-50 g of a rinse active and enough water such that the resulting liquor to fabric ratio is between about 2:1 to 5:1 onto the tumbling clothes according to the mist/spray requirements of the invention;

high-speed spin to remove of at least all free liquor;

optionally, tumble drying in the same apparatus.

optionally, mist application of a finishing liquor

(A) Detergent Formulas (weight %)

| ingredient | 1 | 2 | 3 | 4 | 5 | 6 |
|---|---|---|---|---|---|---|
| Linear alkyl benzene sulfonate | — | 5 | — | — | — | — |
| surfactant (e.g. LAS) | | | | | | |
| Alkyl ethoxylate sulfate | 10 | 10 | 10 | — | — | — |
| surfactant (C25AE_{1.1}S) | | | | | | |
| Alkyl ethoxylate sulfate | — | — | 2 | 10 | 10 | 12 |
| surfactant¹ | | | | | | |
| amine oxide surfactant | — | — | 0.5 | 0.5 | — | — |
| Citric acid | 2 | 2 | — | 2 | 2 | — |
| Enzymes (savinase, duramyl, | 1 | 1 | — | 1 | 1 | — |
| and mixtures thereof) | | | | | | |
| Ethoxylated Amine Polymers² | — | 1 | 2 | — | 1 | 2 |
| Water and minors³ | balance | balance | balance | balance | balance | balance |
| ¹Neodol ® 23-9, Neodol ® 45-7 and mixtures thereof. | | | | | | |
| ²Ethoxylated tetraethylenepentamine (PEI 189 E₁₅-E₁₈) according to U.S. Pat. No. 4,597,898 Vander Meer issued July 1, 1986; PEI 1800 E₇ (according to U.S. Pat. No. 5,565,145 Watson et al., issued October 15, 1996); PEI-600-E₂₀; quaternized, sulfonated ethoxylated hexamethylenediamine | | | | | | |
| # according to U.S. Pat. No. 6,579,839 Price et al. issued Jun 17 2003. | | | | | | |

³Minors may include additional actives such as optical brightener, perfume, suds suppresser, soil dispersant, chelating agents, dye transfer inhibiting agents, additional water, enzyme stabilizers, buffers, solvents, solvatropes, aethetics, and fillers.

(B) Care Formulas (weight %)

| Ingredient | 1 | 2 | 3 | 4 | 5 | 6 |
|---|---|---|---|---|---|---|
| fabric care amine¹ | 8 | 5 | 5 | — | — | — |
| Monoethanolamine | — | — | — | 8 | 5 | 5 |
| HEDP² | 0.8 | 0.4 | 0.4 | — | — | — |
| DTPA³ | — | — | — | 0.5 | 0.5 | 0.5 |
| cationic polacrylamide | 5 | 2.5 | 2.5 | — | — | — |
| Polyacrylamide | — | — | — | 5 | 2.5 | 2.5 |
| BFA⁴ (fabric softener quat) | 20 | 5 | — | 10 | — | — |
| DTMAC⁵ (fabric softener quat) | — | — | — | — | 5 | — |
| Cartafix ® (dye fixative) | 2.5 | 1 | 1 | 2.5 | 1 | 1 |
| MgCl2 | 2.5 | 1 | 1 | 2.5 | 1 | 1 |
| Nonionic surfactant (Neodol ® | 1 | 1 | 1 | 1 | 1 | 1 |
| 23-9) | | | | | | |
| Water & minors⁸ | balance | balance | balance | balance | balance | balance |

¹N′-(3-(dimethylamino)propyl)-N,N-dimethylpropane-1,3-diamine, 1,4-bis (3-aminopropyl)piperizine.
²1-hydroxyethyidene-1,1-diphosphonic acid
³diethylene triamine penta acetate
⁴acrylamide/dimethylamino ethylacrylate methochloride (molar ratio 24:1, K-value 85), or cationically modified polyacrylamides: acrylamide/dimethylamino ethylacrylate methochloride (molar ratio 9:1, K-value 70).
⁵dimethyl bis(steroyl oxyethyl) ammonium chloride
⁶di(hydrogenated tallow)dimethylammonium chloride
⁷available from Clariant, Inc.
⁸Minors may include optical brightener, perfume, suds suppresser, soil dispersant, chelating agents, dye transfer inhibiting agents, additional water, enzyme stabilizers, buffers, solvents, solvatropes, aethetics, and fillers.

While particular embodiments of the present invention have been illustrated and described, it would be apparent to those skilled in the art that various other changes and modifications can be made without departing from the spirit and scope of the invention. It is therefore intended to cover in the appended claims all such changes and modifications that are within the scope of this invention.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

What is claimed is:

1. A process for cleaning fabric articles in a laundering apparatus comprising:
a. placing fabric articles comprising soils inside a treatment chamber of the laundering apparatus;
b. dispensing into the treatment chamber a wash liquor such that the fabric articles are substantially uniformly contacted by the wash liquor;
c. allowing the wash liquor to remain in contact with the fabric articles for a period of time while the fabric article is in motion, continuously or intermittently;
d. dispensing into the laundering apparatus a first rinse liquor comprising water such that the first rinse liquor directly or indirectly contacts the fabric articles, wherein quantity of the first rinse liquor is sufficient to produce enough free water to adequately suspend the detergent active and soils, and the first rinse liquor is thereby converted into a first rinse liquor mixture comprising water, detergent active and soils;
e. removing at least part of the first rinse liquor mixture from the treatment chamber; and
f. optionally, steps (d) and (e) are repeated such that one or more subsequent rinse liquors are applied to the fabric articles, converted to subsequent rinse liquor mixtures, which are at least partially removed from the treatment chamber;
g. optionally, dispensing into the treatment chamber a finishing liquor such that the fabric articles are substantially uniformly contacted by the finishing liquor;
wherein the wash liquor comprises water and a detergent active which has an in-wash fabric-water partition ratio of less than about 0.3, and quantity of the wash liquor is from about 25% to about 200% of dry weight of the fabric articles.

2. The process of claim 1 wherein the quantity of the wash liquor is from about 25% to about 75% of dry weight of the fabric articles.

3. The process of claim 1 wherein step (c) further involves thermal or nonthermal evaporative removal of water.

4. The process of claim 1 wherein the detergent active is a hydrophilic surfactant having a HLB value of at least about 8.

5. The process of claim 1 wherein the detergent active is a hydrophilic surfactant selected from the group consisting of C6-C10 alkyl sulfonates; C6-C10 aryl sulfonates; C6-C10 linear or branched, saturated or unsaturated, cyclic or acyclic alcohols; sulfate, alkoxysulfate, alkoxycarboxylate, alkoxylate derivatives of C6-C10 alcohols; and mixtures thereof.

6. The process of claim 5 wherein the wash liquor comprises an effective amount of the hydrophilic surfactant in water such that the wash liquor is capable of forming a liquid crystalline phase emulsion at a temperature from about 10° C. to about 70° C.

7. The process of claim 5 wherein the wash liquor comprises from about 0.1 to about 10 wt % of the hydrophilic surfactant.

8. The process of claim 5 wherein process further comprising a step of removing water from the wash liquor to concentrate the wash liquor to the level of from about 1 to about 20 wt % of the hydrophilic surfactant.

9. The process of claim 5 wherein the wash liquor further comprises a detergent adjunct selected from the group consisting of bleaches, enzymes, detergent-soil mixing promoting agents, builders, chelants, soil release polymers, optical brighteners, anti-redeposition agents, and mixtures thereof.

10. The process of claim 1 wherein the rinse liquor contacts the fabric articles by an indirect method comprising the steps of: introducing the rinse liquor to an outer chamber to a level below the bottom of the treatment chamber; and rotating the treatment chamber such that the rinse liquor passes through perforations in the treatment chamber to contact the fabric articles.

11. The process of claim 1 wherein quantity of the first rinse liquor in step (d) is from about 5 to about 20 times the dry weight of the fabric articles.

12. The process of claim 1 wherein quantity of each subsequent rinse liquor in step (f) is from about 1 to about 10 times of the dry weight of the fabric articles.

13. The process of claim 1 wherein the rinse liquor mixture is removed from the treatment chamber by a non-centrifugal method.

14. The process of claim 1 wherein the first rinse liquor in step (d) comprises a rinse adjunct selected from the group consisting of dye transfer inhibition polymers, soil suspension agents, hydrotropes, rinse activators, pH modifiers, and mixtures thereof.

15. The process of claim 1 wherein the finishing liquor contains a perfume, a pro-perfume, a soil repellent agent, a soil suspending agent, a hydrotrope, a rinse activator, a dye transfer inhibition polymer, a pH modifier, or mixtures thereof.

16. The process of claim 15 wherein said soil repellent agent is an inorganic nanoparticle or a polymer.

17. The process of claim 1 wherein the amount of wash liquor in step (b) exhibits an absorptive capacity-weighted wash liquor to fabric ratio ranging from about 0.25 to about 2.

18. A detergent composition comprising from about 0.01% to about 30% by weight of the composition of a detergent active, and the balance a polar solvent and optional adjunct ingredients; wherein the detergent active has an in wash fabric-water partition ratio (Qᵢ) of less than about 0.3.

19. The composition of claim 18 wherein at least about 1% to about 30% by weight of the composition is a hydrophilic surfactant.

20. The composition of claim 19 wherein the hydrophilic surfactant has a HLB value of at least about 8.

21. The composition of claim 18 wherein the hydrophilic surfactant is selected from the group consisting of C6-C10 alkyl sulfonates; C6-C10 aryl sulfonates; C6-C10 linear or branched, saturated or unsaturated, cyclic or acyclic alcohols; sulfate, ethoxysulfate, ethoxycarboxylate, ethoxylate derivatives of C6-C10 alcohols; and mixtures thereof.

22. The composition of claim 18 wherein the composition is an emulsion which forms a liquid crystalline phase in the temperature range of about 10° C. to about 70° C.

23. The composition of claim 18 wherein the composition further comprises from about 0.01% to about 30% by weigh of the composition of a detergent adjunct selected from the group consisting of bleaches, enzymes, soil suspension agents, detergent-soil mixing promoting agents, and mixtures thereof.

24. An apparatus comprising;
(1) a treatment chamber for receiving fabric articles to be treated, the treatment chamber having a plurality of perforations in its peripheral walls;
(2) a driving motor mechanically associated with the treatment chamber and is configured to rotate the chamber so that the fabric articles in the treatment chamber are in motion;
(3) an applicator in fluid communication with the treatment chamber such that the wash and/or rinse liquor is dispended into the treatment chamber; and
(4) optionally, an outer chamber capable of receiving the wash liquor and/or the rinse liquor that is not retained in the treatment chamber.

25. The apparatus of claim 24 wherein the driving motor is capable of rotating the treatment chamber at different speed and/or in different directions.

26. The apparatus of claim 24 wherein the treatment chamber comprises at least two rotatable portions and the driving motor is configured to provide relative rotation between adjacent rotatable portions.

27. The apparatus of claim 24 wherein the applicator is capable of dispensing the wash and/or rinse liquor onto the fabric articles to achieve a Spray Uniformity Index greater than about 90.

28. The apparatus of claim 24 wherein the applicator is capable of dispensing the wash and/or rinse liquor in the form of droplets with a D₉₀ of less than about 350 microns.
